(19) United States
(12) Patent Application Publication
(10) Pub. No.: US 2012/0084392 A1
(43) Pub. Date: Apr. 5, 2012

(54) METHOD AND SYSTEM FOR PROVIDING MEDIA CONTENTS FOR A PLURALITY OF NODES IN A DATA NETWORK

(75) Inventors: Alexander Lipfert, Oberhaching (DE); Quirin Hofstätter, Munchen (DE)

(73) Assignee: TECHNISCHE UNIVERSITAT MUNCHEN, Munchen (DE)

(21) Appl. No.: 13/256,310

(22) PCT Filed: Mar. 2, 2010
(86) PCT No.: PCT/EP2010/052606

§ 371 Date: Nov. 23, 2011

(30) Foreign Application Priority Data
Mar. 13, 2009 (DE) 10 2009 012 992.8

(51) Int. Cl. G06F 15/16

(52) U.S. Cl. 709/217

(57) ABSTRACT

A method for providing media contents for a plurality of addressable nodes in a data network, said media contents comprising at least one media file. For each media file to be provided, a decentralized structure managed via a first node is formed so the respective media file is divided into a plurality of sections and an identity value is allocated to the sections, the first node(s) respectively responsible for a sub-interval and for a sub-quantity of sections from the respective media file. In a respective first node, a number of second nodes and corresponding addresses are deposited, the second node(s) specified for providing said sections according to said sub-interval, for which the respective first node is responsible. A receiving node retrieves the addresses of second nodes having sections of said media file by a request to said first node, and downloads the sections from said retrieved addressed second nodes.

The invention relates to a method and a system for providing media contents for a plurality of nodes in a data network, wherein the media contents comprise one or several media files, and the nodes are addressable in the data network via addresses.

Various methods are known from the state of the art, how in a data network of a plurality of nodes, media contents can be provided to other nodes. In that, known solutions also enable streaming of media files, i.e. parallel playing of the media file during its download.

For providing media files, there are so-called client-server solutions, for which a media file is centrally provided by a server and subsequently can be downloaded by various client nodes. This solution has the disadvantage, that the entire amount of data of the file is requested and downloaded via the data network for each client node, so that this causes a high network load.

In order to distribute a media stream in the data network and herewith avoid down-loading of the entire flow for each requesting node, it has been known from the state of the art for packet-based networks to use a so-called IP multicast, for which special streaming routers are used in the network for forwarding data flows. This solution has the disadvantage, that in an existing packet-based network, for example the Internet, changes have to be undertaken with the implementation of streaming routers.

Furthermore, so-called contents distribution networks are known from the state of the art for downloading media contents, which use special proxy computers, which request media streams from the network from a media server and forward them to respective client nodes. For this solution, too, the network infrastructure must be adjusted by implementing suitable proxies.

A further approach for the distribution of media files in a data network has been described in the publication of W.-P. K. Yiu, X. Jin and S.-H. G. Chan, “Distributed Storage to Support User Interactivity in Peer-to-Peer Video Streaming”, IEEE ICC '06, 2006. According to the method presented there, VoD streaming (VoD=video on demand) is enabled in a distributed peer-to-peer network, wherein all videos to be provided are divided into sections, and the sections are provided via the nodes of the peer-to-peer network in a decentralized manner. Since a multitude of videos is managed via the decentralized network, the search for a video file to be respectively streamed is complex and results in delays when the video is played.

It is the object of the invention to create a method and a system for providing media contents for a plurality of nodes in a data network, which without changes to the structure of the data network enable fast and reliable provision of the media contents.

This object is solved with the method according to patent claim 1 or the system according to patent claim 28, respectively. Embodiments of the invention are defined in the dependent claims.

In the method according to the invention, for each media file to be provided in the data network, a decentralized structure managed via one or several first nodes is separately formed such that the respective media file is divided into a plurality of sections and an identity value from an identity interval comprising consecutive identity values,is allocated to each section, wherein the first node/s is/are respectively responsible for a sub-interval from the identity interval and therewith for a sub-quantity of sections from the respective media file.

For providing the sections via the decentralized structure, in the method according to the invention, the addresses of a number of second nodes are stored in a respective first node of the decentralized structure, wherein the second node/s is/are specified for providing the sections according to the sub-interval, for which the respective first node is responsible. In that, second nodes are in particular such nodes, for which, depending on certain criteria, it can be assumed that these second nodes actually contain the respective sections of the media file in their storage. Nevertheless, the availability of the sections in the second nodes needs not be guaranteed.

Downloading of at least part of a respective media file via a respective receiving node is according to the invention taking place by means of respective requests to the decentralized structure. In that, by means of one or several requests to the first nodes in the decentralized structure of the respective media file, the respective receiving node retrieves the addresses of second nodes comprising at least part of those second nodes specified for providing the sections of at least part of the media file. Subsequently, sections comprising the sections of at least part of the media file are downloaded by the receiving node from at least part of the second nodes, the addresses of which were retrieved.

Here and in the following, “downloading a section” shall not necessarily mean that the total amount of information of a section must be downloaded. In fact, only a particular portion of the section may optionally be downloaded, for example such that the contents of the section is provided with reduced quality.

The method according to the invention is characterized by the fact that for each individual media file a separate decentralized structure is formed, which undertakes the management of the sections of the media file. Thus, for each media file, a manageable decentralized network is formed, which enables fast and efficient downloading of the media file by a respective receiving node.

A preferred application of the method according to the invention is its use in a packet-based data network, in particular the Internet. In that, the addresses of the nodes are in particular IP addresses. The method is preferably implemented into the application layer of the OSI reference model as the ALM protocol (ALM=Application Layer Multicast).

In a preferred embodiment, a respective media file contains a playable media stream, in particular an audio and/or video stream. In that, the sections of the media file represent temporally consecutive sections of the media stream, wherein the identity values of the identity interval are allocated to the sections in the playing sequence of the media stream. I.e., the higher the respective identity value, the later is the playing time of the section in the media stream. In that, the method according to the invention is preferably used for the so-called streaming of the media stream, for which a receiving node plays the downloaded sections of the media stream in parallel to their download.

In that, the decentralized structure provided according to the invention for managing sections of an individual media file may in particular be implemented with known peer-to-peer protocols or as a ring structure, respectively, in the data network. In that, the chord ring, well known from the state of the art, is preferably used as the ring structure. The mechanisms of a chord ring for providing and searching for resources may then be used in the method according to the invention.

In a particularly preferred embodiment of the method according to the invention, a receiving node, which downloads sections of a media file, also provides them to other nodes. This is achieved by the fact that the receiving node is deposited in the respective first node, which is responsible for the sections downloaded by the receiving node, with its address as a second node.

In a further embodiment of the invention, a mechanism for protection against the failure of first nodes is provided, whereby reliable downloading of media files is also ensured in case of a failure of a first node. For that, the number of second nodes deposited in a respective first node is replicated in other first nodes, in particular at least in a neighboring node, which is responsible for a sub-interval joining the sub-interval, for which the respective first node is responsible.

In a further, preferred variant of the invention, the number of second nodes deposited in a respective first node is deposited in the form of one or several lists. Preferably, the list/s in a respective first node comprise/s one or several first and/or second lists. The first as well as the second lists may be used to download respective sections from these lists at second nodes. In that, a first list contains second nodes with sections permanently available for downloading by other nodes, wherein the availability of the respective second node is checked by regular exchange of messages of the second node with the respective first node. Herewith, the permanent availability of sections of a media file in the data network is guaranteed. Contrary to the first list, a second list comprises those nodes, which have retrieved addresses of second nodes at the respective first node within a predetermined past period of time. Thus, a second list contains nodes, of which, with a certain probability, it can be assumed, that they also contain respectively requested sections of a media file, since the nodes in the second list have also requested these sections themselves.

For distributing the permanently available sections, in a preferred variant of the invention a receiving node downloads sections from second nodes from the first and/or second list, wherein the sections to be downloaded are selected according to one or several predetermined criteria, in particular randomly. I.e. a receiving node is searching for a respective first node, which manages a randomly selected section, by means of a request, and retrieves the first or second list from this first node. It then downloads the respective section from a second node from the first or second list. In that, the section to be downloaded does not have to be a section, which the receiving node needs for playing the media file it just downloaded. Thus, in the background, beside loading sections of a media file, the distribution of further sections is taking place in the data network, too, whereby at several points in the network, permanently available sections are provided, so that reliable downloading is enabled from various download sources in the network.

In a further embodiment of the method according to the invention, in which the downloaded media file is streamed, two nodes from the first list are more preferred more for downloading a section to be played, the closer the section to be played is at the current playing time of the media file. In this manner, it is ensured that sections of a media file to be played soon are downloaded from reliable sources, which permanently provide the respective sections. Hereby, delays when the media file is played are avoided.

In a particularly preferred embodiment of the invention, a receiving node cannot only participate in the distribution of sections of a media file, but also in the management of the ring structure. In that, depending on one or several criteria, a receiving node is accepted as a first node into the decentralized structure of a respective media file by the fact that the receiving node is assigned with the responsibility for a sub-interval of the identity interval. In particular, mechanisms known from the state of the art can be used for accepting nodes into decentralized structures. Such mechanisms are, for example, known for chord rings.

Preferably, the criterion/criteria for accepting a receiving node into the decentralized structure is/are designed such that for a receiving node, a sub-interval of the identity interval is being searched for for a maximum number of times, the responsibility for which can be taken over by a new node in the decentralized structure, wherein in case no sub-interval is found after the maximum number of times, the receiving node is not accepted as a first node into the decentralized structure. Likewise, there is the possibility that only such receiving nodes are accepted into the decentralized structure, which can provide a predetermined minimum size of resources. In that, resources in particular means respectively available upload rates or storage capacities, respectively, or computing capacities, respectively, of the node. Hereby, it is ensured that only nodes with sufficient capacities participate in the management of the decentralized structure. Thus, overloading of nodes is avoided and the failure safety of the method improved.

In a further embodiment of the method according to the invention, the receiving node to be accepted into the decentralized structure is randomly or according to a predetermined pattern allocated a responsibility for a sub-interval, wherein the predetermined pattern is in particular designed such that more nodes are responsible for sections with lower identity values than for sections with higher identity values. For media files in the form of media streams to the played, hereby the finding is considered, that a user normally decides at the start of playing a media stream already, whether he/she wants to continue watching the media stream or not. Thus, nodes, which manage sections with low identity values, are subject to a higher load than nodes with higher identity values, so that a denser node allocation for sections with low identity values is reasonable.

In a further embodiment of the method according to the invention, in the decentralized structure, a respective first node knows the neighboring node, which is responsible for a sub-interval, which joins the sub-interval, for which the respective first node is responsible, in the direction towards higher identity values, wherein the address of the neighboring node is transmitted to the receiving node by the respective first node upon retrieval of the addresses of the second nodes. In that, for a media stream to be played, the number of requests is reduced, since a receiving node already receives the information about the address of the respective neighboring node, which manages second nodes, from which sections to be subsequently played can be downloaded. In that, the respective first node in particular has further information about the neighboring node, which is transmitted to the receiving node beside the address of the neighboring node and from which the receiving node determines the sub-interval, for which the neighboring node is responsible. Hereby, the receiving node can request the addresses of the second nodes for all sections at once, for which the neighboring node is responsible.

In a further embodiment of the method according to the invention, sections are downloaded by a receiving node depending on one or several priorities assigned for the sections, wherein sections with higher priorities are preferred for downloading. Upon downloading of a media stream to be played, a first time interval is preferably determined for a receiving node, wherein the receiving node, based on its current playing time of the media stream, downloads sections, which in the played media stream are located in the first time interval after the playing time, with a higher priority than other sections. In this manner, there is a prioritized download to that effect that sections to be played soon are preferred for downloading. Hereby, continuous playing of the media stream is ensured. In that, in particular sections within the first time interval, which contain the current playing time, are downloaded with a higher priority than the other sections in the first time interval.

In a further variant of the method according to the invention, beside the first time interval, a second time interval is also predetermined for a receiving node, which is longer than the first time interval, wherein the receiving node, based on its current playing time of the media stream, downloads sections, which in the played media stream are located in the second time interval after the playing time and outside the first time interval, with a lower priority than the sections within the first time interval.

Preferably, a receiving node downloads sections to be provided as permanently available sections with a lower priority than the sections from the first or second time interval after the current playing time. Hereby, it is considered that the download of sections for permanent provision is entirely non-time-critical, since these sections are not required for playing the currently downloaded media file.

In a further embodiment of the method according to the invention, the sections of a media file are respectively divided into smaller sub-sections. In that, upon downloading a section, the entire section, however, also only a selection of sub-sections from the section can be downloaded. Preferably, the sub-sections of all sections of a respective media file are grouped into several channels, which represent several quality levels of the media file. In this manner, with targeted downloading of sub-sections of a channel, a quality-adjusted reproduction of the media file, in particular a quality-adjusted reproduction of a media stream is enabled.

Preferably, for processing the sub-sections, a receiving node reads out information via the sub-sections, in particular in respect of the allocation of the sub-sections to quality levels, from an information file. In this manner, a receiving node can obtain the information, which quality or language, respectively, and the like it can play and which sub-sections it has to select for that.

In a further embodiment of the method according to the invention, information on a respective media file is provided in a meta-container, which can be downloaded by a receiving node. Hereby, the user of the receiving node can be provided with respective information about the provided media files, wherein the user, based on this information, can decide, whether downloading of the media file is interesting for him/her, and which quality and possibly which language he/she wants to choose.

In a further embodiment of the method according to the invention, a plurality of media files is provided via a searchable index in the data network, wherein for each index at least part of the addresses of the first nodes of the decentralized structure formed for the respective media file is deposited. Thus, a receiving node, which has found a media file determined via the index, immediately receives information about access points into the ring structure, so that the receiving node can immediately start the process of downloading the media file by addressing one of the access points.

Beside the method described above, the invention furthermore relates to a system for providing media contents for a plurality of nodes in a data network, wherein the media contents comprise one or several media files, and the nodes are addressable in the data network via addresses. In that, the system manages the plurality of nodes such that each variant of the method described above can be performed with the system. In that, the system is preferably implemented on the individual nodes by respective software, wherein the software enables providing or downloading, respectively, of media files according to the method according to the invention.

Furthermore, the invention relates to a node for use in the method according to the invention, wherein the node is designed such that upon operation in the method it acts as a first node or as a second node or as a receiving node.

Embodiments of the invention are hereinafter described in detail on the basis of the enclosed figures, wherein:

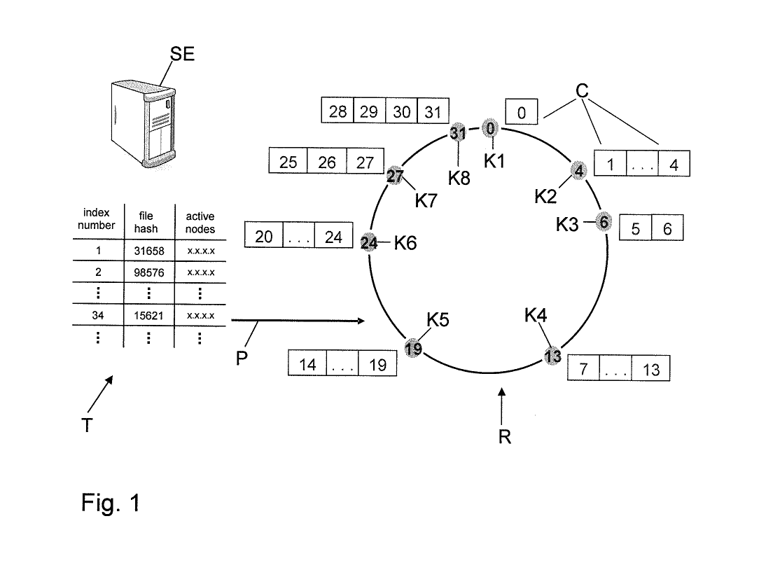

FIG. 1 is a schematic representation of the provision of a video file via a ring structure according to an embodiment of the method according to the invention;

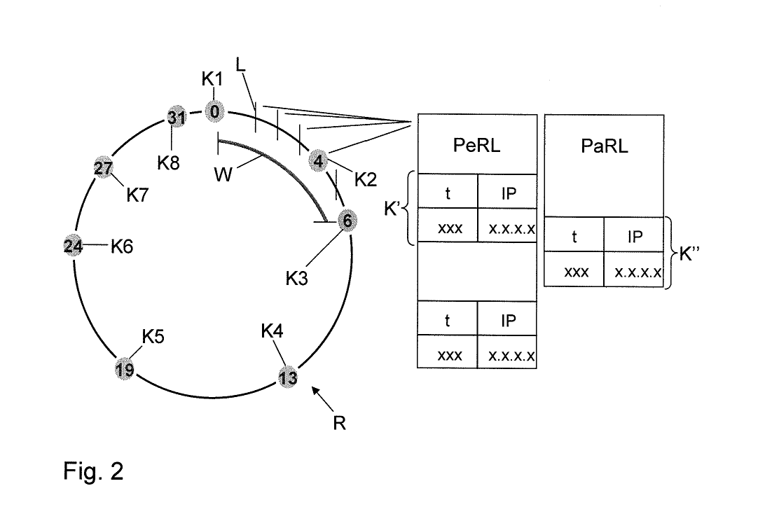

FIG. 2 is a detailed representation of the ring structure shown in FIG. 1, wherein the lists managed in the ring structure are illustrated;

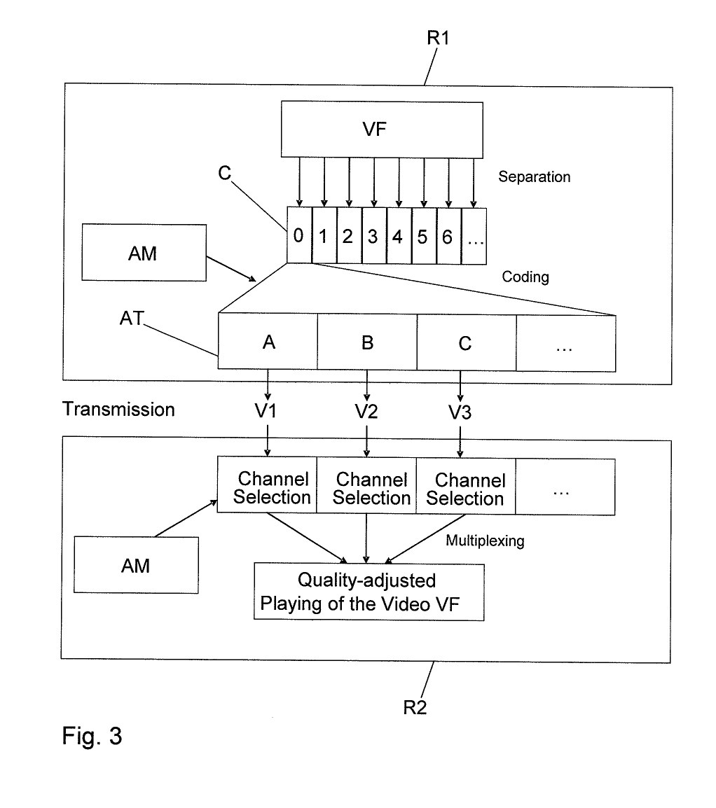

FIG. 3 is a schematic representation of a distribution of the sections of a video file into smaller sub-sections according to an embodiment of the invention;

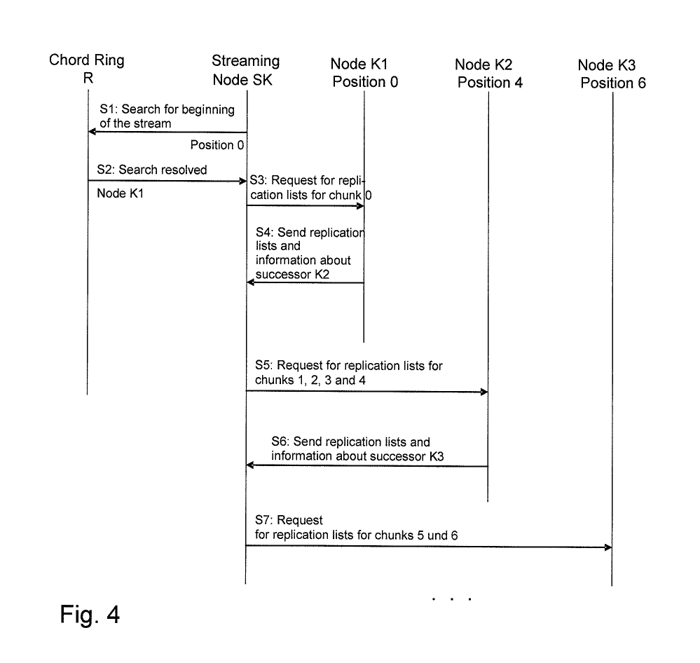

FIG. 4 is a sequence diagram illustrating the search of a node for sections of a video file in a ring structure according to FIG. 1 or FIG. 2, respectively; and

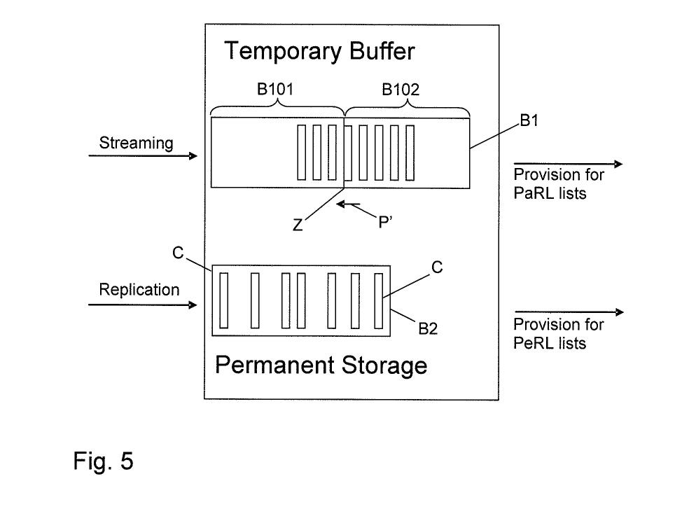

FIG. 5 is a schematic representation of the streaming of a video file in a respective node receiving the video file according to an embodiment of the invention.

With the embodiments of the method according to the invention described in the following, media files are provided in respective nodes of a data network. In that, the data network represents a packet-based data network, which uses the IP protocol in layer 3 of the OSI reference model. The nodes of the data network are respective computers on the Internet, which can be addressed via IP addresses. In that, the peer-to-peer structure described in the following is implemented in the application layer of the OSI reference model in the form of an ALM protocol (ALM=Application Layer Multicast). The subsequent principles, however, are not restricted to certain types of data networks or protocols, respectively, but may also be implemented in other networks and via other protocols.

Based on the method explained in the following, media contents are provided in the form of media files and in particular in the form of video files to be downloaded by nodes. In that, the media contents are not restricted to videos, but may comprise any other contents, like e.g. audio-only files. Provision of the media files in the embodiment described in the following takes place by a respective video provider, which via the Internet provides videos for streaming to other nodes of the network for free or against payment, respectively. In order to enable a node to search for or download, respectively, videos, a respective client software must be installed on the node. The software preferably is provided by the video provider and is designed such that with all nodes using this software, the distribution according to the invention and the download of videos according to the invention are enabled.

Beside the scenario of offering video contents by a commercial provider just described, the method according to the invention may also be used by any other persons or institutions, respectively, for providing media contents. For example, companies can provide material they produced themselves in respect of their products based on the method according to the invention, and private persons likewise can exchange their own video material with other users.

In the scenario shown in FIG. 1, a commercial video provider provides video files for downloading by users via a server SE. In that, the users are represented by respective nodes representing computers, which are operated by a user and have an Internet connection, so that they can be addressed via a respective IP address. On the nodes, via which the services of the video provider are used, respective client software is respectively installed. In order for the video material provided also to be found by other nodes, the respective video files are indexed by the video provider within the scope of an index process. In the embodiment of FIG. 1, this index process takes place as a central process on the server SE. However, there also is the possibility that this process is undertaken as a distributed process, so that diverse powerful computer nodes are involved in this process.

As suggested in FIG. 1, a respective table T is generated by the index process, in which each video provided is allocated an index number, wherein in FIG. 1, as an example, index numbers 1, 2 and 34 are suggested. In that, each index is allocated a file hash generated via a hash function, on the basis of which the individual video files can be distinguished and which can be searched for in order to find video files. In the table T shown, it is furthermore stated for each index, which active nodes are part of a ring structure, which is allocated to the file. The ring structure will be explained in more detail in the following and is suggested in FIG. 1 with reference R. Thus, based on the index provided, a node can search for respective video files, wherein the node is also provided with information about respective active nodes for a video file found, which serve as an access point for the searching node for downloading the video.

A substantial aspect of the method for providing video contents explained in the following consists in the fact that for each video file, a ring structure R is formed, which is managed in a decentralized manner, wherein the assignment of a video file to a ring structure is schematically suggested by the arrow P. For the generation of this ring structure R, the respective video to be provided is divided into a multitude of sections, which hereinafter are also designated as chunks. In that, each chunk contains a temporal section of the played video file. In the scenario of FIG. 1, the video file is divided into 32 chunks, which are suggested by respectively numbered squares 0, 1, . . . , 31 and at least partially designated with reference C. Thus, each section is assigned an identity value from a 5-bit interval of identity values, wherein a higher number of an identity value represents a later temporal section of a video. Hereby, the ring structure shown in FIG. 1 is created, wherein each chunk is allocated a position on a 5-bit ring with 32 positions.

In that, the chunks C are managed by respective nodes, which according to claim 1 are designated as first nodes. These nodes are such nodes, which can also download respective video contents from other nodes. Thus, the nodes using the service of the video provider are also involved in the management of respective videos. In that, in the scenario of FIG. 1, not every position of the ring is occupied with a node. There rather exist a total of eight nodes K1 to K8. In that, node K1 occupies position 0 of the ring, node K2 position 4, node K3 position 6, node K4 position 13, node K5 position 19, node K6 position 24, node K7 position 27, and node K8 position 31. In that, each of the nodes manages the chunks at the position, where it is located, as well as at all previous positions up to the previous node. I.e. node K1 manages chunk 0, node K2 chunks 1 to 4, node K3 chunks 5 and 6, node K4 chunks 7 to 13, node K5 chunks 14 to 19, node K6 chunks 20 to 24, node K7 chunks 25 to 27, and node K8 chunks 28 to 31.

The management by the ring structure R using nodes K1 to K8 preferably takes place based on known peer-to-peer protocols. Particularly preferred, the chord ring known from the state of the art is used for this, which provides respective mechanisms for managing and searching for resources in the node involved in the ring. However, any other peer-to-peer protocols may also be used, using which nodes with responsibilities for intervals of identity values can be searched for within a distribution network, and which further provide a mechanism, using which new nodes can be accepted into the distribution network, or nodes can also be removed from the distribution network, respectively.

Each of the individual nodes K1 to K8 in the ring structure R is allocated a number of further nodes of the data network, which contain the respective chunks, for which the respective nodes K1 to K8 of the ring R are responsible. In that, these nodes containing the chunks correspond to the second nodes in terms of claim 1 and are managed in respective lists, like suggested in FIG. 2. In that, for each identity value of a chunk in the ring structure R, there exists a permanent replication list, which is designated as PeRL, as well as a current replication list, which is designated as PaRL. In FIG. 2, by way of example, a few positions of identity values of chunks are suggested between nodes K1 and K3 by vertical lines, of which for reasons of clarity only one line is designated with reference L. In that, node K2 manages the identity values of chunks 1 to 4, so that in this node, a PeRL as well as a PaRL is deposited for each of the chunks.

In the PeRL list for a respective chunk, all nodes with their node access points (i.e. address and port) are collected, which permanently provide the chunk. As will be explained in more detail further below, respective mechanisms provide for the fact that there are a sufficient number of nodes permanently providing chunks for downloading. Such nodes also include, among others, those nodes having a complete copy of the video. In this connection, permanent means as long as the respective node is involved in the network for distributing the videos. FIG. 2 schematically shows the structure of a PeRL list. The PeRL list contains an entry for each node, which permanently provides the respective chunk. By way of example, an entry for a node K′ is highlighted. In each entry, the point in time t is specified, at which the respective entry was updated last. Likewise, the respective IP address of the node is stated. In the PeRL list, in particular also nodes are contained, which provide a complete copy of the video. These nodes are especially marked. In that, for a permanent update of the entries in the PeRL list, so-called keep-alive messages, which are commonly known from peer-to-peer protocols, are exchanged between the individual nodes, as will be explained in more detail further below.

Beside the PeRL list, FIG. 2 also shows a PaRL list for a chunk. In the example of FIG. 2, this list contains only one entry for a node K″. Nodes are entered into this list, which requested the respective chunk, to which the PaRL list belongs, within a predetermined past period of time. In that, beside the IP address of the respective node, each entry in the PaRL list also represents the point in time t, at which the chunk was requested. This PaRL list is not updated with keep-alive messages. Rather all nodes are entered into the list, which requested the chunk, and which following occurrence of a certain condition, following expiry of a predetermined period of time, at the latest, are deleted. In this manner, it becomes possible to compensate for high temporal fluctuations in the demand for a chunk, because it can be assumed that a node, which requested a respective chunk, also downloaded it and thus can provide it. Thus, beside the nodes from the PeRL list, also nodes from the PaRL list can be used for downloading chunks.

The ring R according to FIG. 1 or FIG. 2, respectively, is used by respective streaming nodes SK (FIG. 4), which correspond to the receiving nodes in terms of claim 1, to consecutively download respective chunks, wherein the information about the nodes, which provide the chunks, are retrieved from the ring via the nodes K1 to K8 contained therein. Streaming of the video provided by ring R via a streaming node is suggested in FIG. 2 by a respective streaming window W. This window represents a minimum buffer size for streaming nodes, which for playing the video is filled with chunks and which during playing the video should remain filled, if possible. In the scenario of FIG. 2, the streaming window W comprises six chunks and the streaming node is just starting to play the video at position 0. With the playing time advancing, the streaming window moves ahead with the playing time shifting clockwise. With respective mechanisms, which will be explained in more detail further below, it is ensured that the streaming node preferably always downloads such chunks, which are located within the streaming window W, in order to hereby guarantee playing of the video without delays.

Before the actual download of a video is started by a streaming node, the streaming node first requires the respective download sources, which are contained in the PeRL or PaRL lists, respectively, explained before. Therefore, the streaming node makes queries to the ring R for the chunk numbers it requires, wherein known mechanisms of the chord protocol can be used for that. In that, the query is directed to one of the access points of the network, which are deposited in the table T for the video to be respectively downloaded. In that, it doesn't matter via which access point a respective request to the ring is made, since based on the chord routing, the request securely reaches its target directly. Each request, which has reached its target, is responded to by the responsible node in the ring with the transmission of the respective PeRL and PaRL lists for the chunk respectively requested.

In contrast to conventional file sharing, various parts of the video are not downloaded randomly or as available, but depending on the current playing time. This has already been explained above based on the streaming window W used. In that, the size of the streaming window indicates, how far in advance the video should be downloaded in order to enable certain playing, and to compensate for possible download fluctuations. The streaming window, however, should also not be too big, since this is always associated with a playing delay until the window has been filled. In that, the buffer time predetermined by the streaming window is directly associated with a respective buffer size to be provided in the streaming node. In particular, the buffer size to be provided is the product of average playing rate and buffer time. From the buffer size, it may then be directly determined, how many chunks have to be downloaded in advance in order to fill this buffer. The number of chunks is in particular the quotient of buffer size and chunk size.

Before the process of providing and downloading of a video based on a respective ring is described in detail, the structures of the video files to be downloaded used in the embodiment described in the following will be explained first.

The subdivision of a respective video file into smaller chunks serves the easier organization of the normally very large streaming files. The responsibility for a chunk is deposited at a respective identity value in the ring R, which there is managed by a node. The actual video information is replicated at a high number of various nodes, wherein the information, which nodes contain the respective chunks, is saved in the PeRL or PaRL, respectively, lists explained above in the node responsible for the respective chunk.

Before a node initially posts a video file in the network, a few preparatory steps must be performed by the initial source node. In particular, first, the video file must be checked for its suitability for streaming. If the file is suitable for streaming, the entire file is recoded with an efficient and standardized coder, e.g. based on MPEG-4/AVC or H-264, respectively. Finally, the video is converted into the selected file structure. For finding the video, a unique video hash value is subsequently formed, and furthermore characterizing information of the video is collected and stored in a respective container for meta-information. This container will be explained in more detail further below.

Following completion of these preparatory steps, a new entry for the video is generated in the index list, which in FIG. 1 is designated with reference T. There the details and the meta-container are deposited and checked. Following successful examination, the video stream is published and the list T of access points to the chord ring with their IP addresses created. In this list, first only the initial source node is entered. At certain intervals, the list is updated and new addresses added to the chord ring are added.

In the embodiment of the method according to the invention described here, a video stream is not only divided into smaller chunks, but the chunks are again divided into smaller sub-sections, which in the following are designated as atonks (atonk=atomic chunk). In that, an atonk designates part of the respective chunk and is marked with a label. This division is once again illustrated in FIG. 3. In that, in the upper rectangle R1, the transcoding process of the original video file for the formation of chunks and atonks is represented. First, there is the separation of the video VF into individual chunks C, of which in FIG. 3 the chunks are suggested with numbers 0 to 6. Each individual chunk C is then coded, whereupon in the chunk respective smaller atonks AT with assigned labels A, B, C, etc. are generated. In that, in FIG. 3 the coding is suggested for the chunk with number 0.

For the formation of atonks, a specified atonk map is used, which in FIG. 3 is designated with AM. The labels of the individual chunks are continued across the entire video file, i.e. each chunk contains atonks AT with respective labels A, B, C, etc. With the respective choice of the labels, channels can be formed, wherein one channel is assigned all atonks of one label. Depending on the label selected, upon downloading a chunk, only those atonks according to the selected label are then transferred. In FIG. 3, a transmission in respective video streams V1 or V2, respectively, or V3, respectively, for atonks with the labels A or B, respectively, or C, respectively, is suggested.

Within the lower rectangle R2 of FIG. 3, decoding of the respectively downloaded atonks with a decoder of the streaming node is shown. The individual downloaded streams may then, based on the same atonk map AM, which was used for coding already, allocated to the respective labels A, B, C, etc. In the embodiment shown in FIG. 3, the individual labels represent various quality levels of the video. Label A is the lowest quality level, and by gradually adding the chunks with labels B, C, etc., the reproduction quality of the video is further increased. Multiplexing the chunks with the different labels, quality-adjusted playing of the video can thus be achieved.

There are various possibilities, how different channels can be formed by marking the atonks with labels. In the following, a few examples are given for respective channeling of the video stream by means of atonks. In the simplest case, the video and audio information of the video file may be deposited in a compressed manner, but separable among one another into the atonks. Depositing takes places sequentially and may thus be decoded again very easily. In that, however, different quality levels, as mentioned above, are not possible.

A further variant is image channeling, for which the video material is subdivided into three channels. If the material is based on the MPEG standards, then in an encoded video, there are three differently important types of image frames. The most important ones are the so-called I-frames, which are present as still images. They occupy the largest storage space, and therefore only occur at predetermined intervals in the coding. Between individual I-frames, there are the P-frames and B-frames, which are encoded with substantially more loss. Upon playing, these can only be calculated using previous I-frames or other P-frames. If all frames of one type within one chunk are allocated to one atonk label, then three video channels are obtained. The I-frame channel is required for playing in any case and provides some kind of basic quality. By adding the channel with the P-frames and the channel with the B-frames, the quality of the video can be respectively increased.

A further type of channeling based on atonks is the so-called description channeling. This channeling enables the subdivision of the video material into any number of channels. In that, a method known from the state of the art is used, which is designated as “multiple description coding”. This method generates various descriptions of one and the same video material. In that, a layer coder generates a base layer and any number of expansion layers from the original. The base layer is—analog to image channeling of the I-frame channel—always required for playing. Via the expansion layers, any number of quality levels may subsequently be introduced. If each of these layers or descriptions, respectively, is allocated a respective atonk label, there is the possibility to introduce any number of channels and thus quality levels, as is suggested in FIG. 3 already.

Furthermore, so-called resolution channeling can be used for generating the atonks. By subdivision of the video material, this channeling generates a very high number of channels. In that, with repeated sub-scanning, a reduced resolution of the video is generated. Following each sub-scanning, the old resolution is generated again for each image of the video by means of interpolation. The interpolation error resulting from that is used further, the interpolated images are discarded, and the sub-scanning process is repeated based on the resolution level just used. These steps are repeated until the desired smallest resolution has been achieved. The version of each image reflects the basic channel. Each sub-scanning step performed beforehand provides the material for an expansion channel. Via these, the respective interpolation errors of the individual images are transferred. These error values have a very high redundancy and therefore can be compressed very well. Using the basic image and the associated interpolation errors, the receiver in the form of the streaming node can reconstruct an almost error-free original image. In this manner, a very high number of quality levels of the video can be generated.

Chunks and atonks differ in several characteristics. Downloaded chunks can be played independently; for atonks, this is possible to a certain extent only. Atonks can have very different sizes, while chunks have the same size. Depending on the coding used, not all atonks must be downloaded for playing a chunk. The video, however, is stalled if not at least the most required parts of all chunks are downloaded.

The prerequisite for division of the chunks into atonks is the atonk map mentioned above already, which is deposited at the start of a chunk and with each identity value in the chord ring. In that, the atonk map gives instructions, which atonks have to be downloaded in order to obtain a certain quality or which atonks are the most important ones. Atonks can contain video or audio information and are marked with a label. The significance of a label must be defined in the atonk map. The separation of a video into chunks may, depending on the encoding used, take place before or after encoding and conversion of the video into the desired file structure. The file is then suitable for streaming and suitable for distributed organization within the scope of the ring structure R shown in FIG. 1 or FIG. 2, respectively. With one of the known hash functions, a hash value is generated for the video to be provided. For that, characterizing values of the video, like e.g. posting date, video size, file structure or the like can be used.

In the embodiment of the method according to the invention described here, metafiles are used for organization of the video distribution, which contain important information about the respective video in a meta-container. In that, a meta-container represents an object, in which several meta-files are collected and saved into a video stream. The meta-files themselves cannot be modified, however, new ones can be added to the meta-container and meta-files may possibly also be removed. In the meta-files, various characterizing pieces of information on the video file are saved. In particular, further sound tracks of a video may also be deposited in a meta-container.

In a particularly preferred embodiment, the meta-container consists of a video meta-file, a contents meta-file, an audio meta-file as well as possibly further audio tracks. In the video meta-file, information on the video file and the structure of the video stream is collected. This information in particular comprises the hash value of the video provided, the size of the entire video file without audio, the number and size of the video chunks, the structure and size of the atonks, chapter transition marks, quality level characteristics as well as the video coders used.

In the contents meta-file, characterizing information on the video are collected. These serve the users as an indication before playing the video already, which video it is. The contents meta-file in particular comprises the hash value of the video, a brief video description, information on the actors, producer, publisher and genre of the video as well as possibly further characterizing information.

In an audio meta-file, information on the respective sound track is collected. In particular, this file comprises the hash value of the video, the size of the entire sound track, the number and size of the sound chunks, the audio encoders used for the sound track as well as audio meta-data, as well as language, quality of the audio track and the like.

In the following, the download of a video by a respective streaming node based on an embodiment of the method according to the invention is explained in detail. First, on the respective computer of the streaming node, a user starts the client software for performing the method according to the invention. Within the scope of the software, the user can select a certain provider for downloading a video. The software then contacts the previously known address of the provider server, which in FIG. 1 is designated with SE. Following login, a current list with information on the existing video streams can then be downloaded to the streaming node. If the user of the streaming node is looking for a certain video, he/she then can also sort the video streams by certain criteria like genre, actor, language and the like. The search either runs locally on the streaming node, wherein in this case the complete list of available video streams must be downloaded. However, there also is the possibility to send a request to the server of the provider, which then delivers a list of possible results. The information for that is extracted from the meta-container described above, wherein in particular the contents meta-file serves the user of the streaming node for decision making.

Following selection of a certain video stream via a streaming node, the selection of the currently available access points is downloaded, which is deposited for the respective video in the list T of FIG. 1 in the column “active nodes”. Before the actual streaming starts, first the streaming node checks, whether it can at least reach one of the access points and whether at this point the respective chord ring, via which the chunks of the video are managed, is available. Subsequently, it is ensured based on a compatibility check, whether and with which restrictions the video stream can be played on the streaming node.

Only when the above conditions are sufficiently fulfilled, the streaming node enquires, in which language and quality the streaming is to be watched. For that, only those variants are available, which according to the compatibility check are considered feasible and are available according to the meta-container. Alternatively, the user of the streaming node may, depending on the provider, also select the complete recording, for which the stream is recorded and can only be played following complete download.

During the enquiry of information by the streaming node just described, processes for the video streaming, the download of permanently available chunks to the streaming node as well as the entry of the streaming node into the chord ring are started. These processes will be explained in the following.

In the embodiment described here, a streaming node, which wants to download chunks from the respective chord ring, may under certain conditions also become part of the chord ring. I.e. in this manner, a streaming node is also involved in the management of chunks of a video. In that, there are various possibilities, which identity value and thus which identity interval the streaming node is being allocated to. In one variant, the streaming node independently selects an identity value from the chord ring via a random process and checks its allocation in the ring with a special search. If the respective identity value is occupied by a node already, this process is repeated until a free position was found. The process may possibly also be stopped following a certain number of requests, wherein in this case the streaming node does not become part of the chord ring.

In a further variant, the identity value, which is to be occupied by the streaming node, is selected according to a fixed pattern. In that, it may be considered in particular, that frequently only the first minutes of a video are played by users. In many cases, a user notices at the beginning of the video already, that he/she doesn't like this video and stops the streaming. In this manner, higher loads are caused for ring positions with lower identity values than for ring positions with higher identity values. This fact can be considered by a respective entry pattern. In that, the streaming node knows the entry pattern in advance. This pattern could possibly also be deposited in the meta-container of the video. The pattern describes, in which fixed order the positions in the respective chord ring are to be occupied. Consequently, the streaming node sends a special request to the first identity value of the pattern. If this identity value is occupied, then the requested node forwards the request to the next identity value in the pattern. This is repeated until the first free position was found, at which the streaming node then binds to the ring. The search may possibly also be stopped, when a specified number of requests have not resulted in a free node.

It may be possible that the search for a free node takes long with an almost completely occupied chord ring. Since, however, the actual playing of the video stream is not bound to the final entry of the streaming node into the ring, herewith, however, there is no delay during streaming. Once the streaming node found a position in the chord ring, at which it will access the chord ring, the mechanisms specified by the chord protocol for entry into the ring are performed. These mechanisms are commonly known from the state of the art and will therefore not be explained in detail. For that, the streaming node newly added to the ring must take over any management tasks for maintenance of the ring, generate the routing table and keep it up to date, and take over the responsibility or competence, respectively, for the assigned part of the ring. In that, the responsibility extends from the position at which the streaming node enters the ring, up to the position of the node located in the previous node. The added streaming node must furthermore also keep the respective PeRL or PaRL lists of the respective identity values up to date and reply to or forward, respectively, queries.

In the embodiment of the invention described here, furthermore a redundant copy of the information collected in a node of the ring is generated, in order not to risk a loss of information in case of the failure of a node. In that, the collected information of a node are redundantly stored in the subsequent node and updated with the original at regular intervals. If a node of the ring fails, then the subsequent node can immediately take over the area of competence of the failed node. In that, it already has an almost up-to-date version of the PeRL or PaRL lists, respectively. In case of frequent node failures, too, the management in the network is thus ensured as far as possible.

Should the case occur that the streaming node cannot enter the chord ring, because every position in the ring is already occupied with a node, then various variants are possible. In a first variant, the streaming node does not enter the ring. In that, as mentioned above already, the attempt of entry into the ring can be stopped, when a certain number of entry attempts failed due to occupied ring positions. Such nodes then do not take over management functions in the ring. There may also be the possibility that such nodes must save a higher number of chunks to be permanently provided, wherein the permanent storage of the chunks takes place in parallel to the streaming, as will be explained in more detail further below. The entry of a streaming node into a ring may possibly also be attempted again at regular intervals. If the number of nodes in the ring should then have reduced, the entry of the node into the ring is possible.

In a further variant, entry into the ring may also be made dependent on characteristics of the node. For example, only such streaming nodes may enter the ring, which exceed a certain resource size, wherein the resources in particular concern the available upload rate or research capacity, respectively, or the available storage, respectively, of the node. All streaming nodes, which have not entered the ring, update a list with access points into the ring at fixed intervals, wherein an updated list, for example based on the list T according to FIG. 1, can be downloaded from the video provider.

With the variant described just now, for which only nodes with sufficient resources enter the ring, it is prevented that weak nodes in the ring are overloaded. Naturally, in this variant, too, there may be a fully occupied ring. In this case, the variants previously described are then used, i.e. the node does not enter the ring.

According to the above embodiment, a streaming node should get involved in the organization of the respective chord ring by entering the ring. However, there may also be the case that the streaming node does not become part of the ring. Contrary to that, it is ensured in the embodiment described here, that a streaming node, however, participates in the distribution of the video in any case, by permanently providing available chunks for other nodes. Herewith, it is achieved that each streaming node is also forced to provide its upload capacity for other nodes. Nodes, which permanently provide certain chunks, are on the one hand the nodes, which have a complete copy of the video, and thus permanently contain all chunks. Furthermore, all the nodes, which only stream the video itself, take over the replication responsibility for a certain number of chunks, as long as they are connected to the network. Thus, a replication of the chunks is achieved in a plurality of nodes, whereby the failure safety of the network is increased.

If, for example, a node in the network fails, with a respectively high replication of the chunk only a small part of the chunk availability is lost. This results in stability and failure safety. The higher the chunk replication is, the more sources does a streaming node have, from which it can choose chunks for downloading. If during the download of a chunk a source node fails, the atonks from this source no longer reach the receiver completely. Since, however, there also are a sufficient number of other sources, from which atonks can be successfully downloaded, this failure does not result in interruptions, but only in a worse quality. In that, it has to be considered that in the embodiment of the method according to the invention described here, multiple downloads for the same chunk as well as different grades of quality are made possible upon encoding of the video.

The permanent chunk replication for each replicated chunk is performed for a specified number of times. In that, the replication of a chunk performed by a streaming node is performed according to a determined scheme. First, the streaming node selects a chunk number from the ring, from which it is just streaming a video file. In that, the selection can be random. Once a respective identity value was chosen and the node in the chord ring responsible for this identity value was found based on a respective search, the streaming node sends a request to the node found, with which the PeRL and PaRL lists of the respective chunk number are requested. Following receipt of these lists, the chunk is downloaded completely with all sound tracks and the respective meta-container of the video.

As soon as a streaming node completely downloaded a new chunk to be replicated, it has itself entered into the PeRL list of the respective node, which is responsible for the chunk in the chord ring. In order to always keep this list up to date, so-called keep-alive messages are exchanged at regular intervals. For that, the streaming node sends a message to the chord node responsible for the respective identity value for each replicated chunk, even following completion of the streaming, and thus informs said node that the replication is still available. Since it already knows the address of the node responsible for the identity value, the keep-alive mechanism normally consists of a simple exchange of messages. If nothing changed in the responsibilities in the chord ring, the message is returned acknowledged. Otherwise, a search for the chunk number must be sent to the ring, and following resolution, the keep-alive messages must be sent to the new address again.

In the following, the actual video streaming by the streaming node will now be explained. In that, it is exactly regulated, in which manner a streaming node requests respective PeRL or PaRL lists, respectively, and downloads the chunks from the nodes listed therein. Normally, a user of the streaming node wants to start the video to be streamed right at the beginning. Nevertheless, in the method described here, a user may also start the video at another point than at the beginning, if, for example, he/she has already seen the start of the video. In both cases, the starting point of the video selected by the user has to be implemented into a respective chunk number, the chunk of which is to be downloaded first. A node, which is brand new in the streaming network, will start with chunk number 0. For jumping participants, the chunk numbers must be calculated directly following the respective selection. This can be realized in a simple manner, since the number and size of the chunks as well as the length of the streams is known via the meta-container described above.

Once the chunk number of the chunk to be downloaded first has been determined via the meta-container, the streaming node starts a search for the corresponding identity value in the chord ring. In that, the commonly known search mechanisms of the chord are used, wherein the query is forwarded and processed between the chord nodes in a suitable manner, until the competent chord node is found. Following finding the competent chord node, the respective replication lists of the chord node, the meta-container of the video as well as the atonk map are sent back to the streaming node in response. Additionally, the competent chord node adds still further information about the current chord ring structure. The mechanism of additionally adding information is in the following designated as “successor piggyback”. In that, the following information is added to the response message:
the competent chord node's own address;
the identity value or the position, respectively, which the competent chord node itself takes in the chord ring;
the address of the immediately subsequent node in the chord ring;
the identity value or the position, respectively, which the immediately subsequent node takes in the chord ring.

Based on the above information, the streaming node can detect which chord node is responsible for the next chunk number in the chord ring to be requested and which address this node has. In this manner, it is achieved that a streaming node does not have to send a new request to subsequent nodes in the chord ring for downloading new chunks, since it already knows the subsequent node in the chord ring. Hereby, the network traffic is reduced.

FIG. 4 once again shows, in part, the download of the PeRL or PaRL lists, respectively, according to the successor piggyback method. In that, the PeRL and PaRL lists are generally designated as replication lists. The diagram of FIG. 4 is based on the chord ring R shown in FIG. 1 or FIG. 2, respectively. Furthermore, it is assumed that the stream at the beginning of the video, i.e. at position 0, is to start. First, in step S1, the streaming node SK directs a query to the chord ring R to find position 0. Following resolution of the search, in step S2, the address of node K1 is returned to the streaming node. In step S3, the streaming node then sends a request for the replication lists for chunk 0 to the node K1. The node K1 responds to this request in step S4 by sending the respective replication lists, incl. information about the subsequent node K2, to the streaming node SK. Subsequently, the streaming node SK may then download the respective chunk 0 from one or several of the nodes from the replication lists.

In the next step S5, the streaming node requests the respective replication lists of the chunks directly from the subsequent node K2, for which the subsequent node K2 is responsible. These are the replication lists for the chunks 1, 2, 3 and 4. Thus, for these chunks, no further queries to the chord ring are required. Then, in step S6, the node K2 sends the respective replication lists as well as information about the subsequent node back to K3, whereupon the downloads for that are initiated, too. The method is continued with the streaming node SK directing a respective request for replication lists for chunks 5 and 6 to the subsequent node K3 in step S7, whereupon the respective replication lists are transmitted to the streaming node SK and the down-load of the next chunks may start.

As results from FIG. 4, with the permanent transmission of the address and the chunk position of the subsequent node, no multiple queries to the chord ring are required, since the streaming node always knows, which subsequent node manages the next chunks to be downloaded. If a streaming node watches the video in sequence, it thus moves clockwise from identity value to identity value in the chord ring according to FIG. 1 or FIG. 2, respectively, without having to start a further search in the chord ring. Following each request, the node is additionally informed about current changes, for example changes in responsibility in the chord ring. Only when the node jumps in the stream or a connection to one of the chord nodes fails, a new query must be sent to the ring.

In small networks with few nodes involved, the PeRL or PaRL lists, respectively, do not grow into remarkable sizes. In this case, it is not a problem to distribute these lists completely. From a certain number of nodes involved in the distribution of the video on, however, it is no longer advisable to distribute the complete lists for permanent distribution. This is also not required, since a streaming node only picks out a small number of sources for downloading, from which it downloads the chunks.

Consequently, from a certain size of entries on, the PeRL list is no longer distributed in its entirety. The chord node, of which the list is requested, rather selects only a certain sub-quantity of random sources and sends their information to the streaming node. In that, however, it should be observed that each request is served with other sources. The chord node could, for example, note in the PeRL list, how often a source has already been sent. Therewith, a good uniformity of the sources used for the download can be achieved. In contrast to the PeRL list it is required for the PaRL list in the embodiment described here, that this list is transmitted to each streaming node in its entirety, as will be explained in more detail further below.

A streaming node always downloads only the sound track and the video quality it requires, i.e. the respective atonks of the video just streamed. With each request for the replication lists, the streaming node is automatically entered as the source into the respective PaRL list of the requested chunk. For that, the address and the time stamp are deposited. The respective chord node, in the PaRL list of which the streaming node is entered, however, does not have any information about which atonks and whether the just entered node has downloaded something at all. Furthermore, for the entries of the PaRL list, no keep-alive messages for checking the sources are exchanged, as is the case with the PeRL lists. Thus, in the PaRL lists, nodes are listed, for which only the probability is high, that they have the chunk according to the PaRL list at least partially and can provide it. Contrary to the PeRL entries, thus there are no guarantees for the PaRL entries as to the availability of the sources.

Since the PaRL list always is to be distributed in its entirety, it must not get too big. In order to achieve this and to simultaneously increase the probability of availability of the sources from the PaRL list, in the embodiment described here, a few limiting measures are used. In particular, nodes from the PeRL list are not accepted into the PaRL list. Furthermore, following expiry of a fixed period of time, old entries in the PaRL list are deleted. Furthermore, a streaming node, which upon downloading found a non-available node in the PaRL list, indicates the lacking availability of the node to the competent chord node. This then deletes the entry once it has checked it itself. Finally, the PaRL list is also limited by a maximum size of entries, and when this value is exceeded, the oldest entries are deleted in order to make space for new entries in the PaRL list.

The above measures ensure that the PaRL list is always kept as small as possible. Additionally, the probability is increased, that the nodes in the PaRL list really have the chunk, since following expiry of a fixed period of time, old entries are deleted and the non-availability of nodes is signaled to the chord ring. Furthermore, with the restriction of the PaRL list to a maximum size, it is also guaranteed for large networks that the respective chord node in the ring is never overloaded. The use of PaRL lists offers a number of advantages, as will be explained in the following.

A streaming node, which has downloaded a chunk, first holds it in a buffer, before the chunk is actually played. Instead of immediately deleting the file following playing, in the embodiment of the invention described here, the node leaves the chunk in its storage for a while. This can also be designated as backward buffering, since in relation to the playing time, the chunk moves backwards. On the one hand, the backward buffer serves for the case that the user wants to play a scene again immediately after it has been played. On the other hand, the chunk can be offered for downloading by other nodes via the PaRL list for longer. The size of the backward buffer can correspond to the commonly used buffer, which is represented by the streaming window W in FIG. 2. The backward buffer may possibly even contain the entire stream played so far. This ultimately depends on the available storage space. The use of the PaRL list in combination with the backward buffering just described offers advantages, as will be explained on the basis of the following examples.

It is assumed that the streaming node X starts playing at chunk number 0, which it has downloaded already. Simultaneously, the streaming node is in the buffer build-up phase with a buffer size of six chunks. Thus, it downloads the chunks 1 to 5 and stores them in the buffer. The node X is thus entered in the PaRL lists for the identity values 0 to 5. Its playing time now moves over from chunk number 0 to chunk number 1. The video stream is served from the buffer. Another node Y also enters the network and likewise starts streaming at chunk number 0. Since X is in the PaRL list of chunk number 0, the node Y can now download chunk 0 from node X and play it. In the same manner, node Y can also download chunks 1 to 5 from node X for buffer build-up.

Thus, in this example, node Y downloads all chunks 1 to 5 from node X. In that, the video quality of the chunks corresponds to the quality, with which the chunks were downloaded at node X. Via the PaRL list, node Y has the information that node X has the desired chunks 0 to 5. In that, Y obtains chunk 0 from the backward buffer of node X and chunks 1 to 5 from the normal buffer. Without backward buffering, node Y would have to look for another source, since chunk 0 would no longer be available for node Y. Using the PaRL list, thus, on the one hand, the nodes in the PeRL list are relieved, and on the other hand, the entries in the PaRL list contain a sequential pattern. According to the example above, node X appears in the PaRL lists for chunk numbers 0 to 5, which node Y can find out by comparison of these PaRL lists. If node Y could thus successfully download chunk 0, this, with a high probability, also works for the subsequent chunks 1 to 5. In addition, a push service is also perceivable, if node X likewise has the chunks following chunk 5. As soon as node Y has successfully received chunks 1 to 5 from node X, X automatically also sends the following chunk 6 to Y. In that, X sends the chunks in sequence to node Y until Y stops the push or no more chunks are contained in the buffer of X.

Thus, in total, several chunks can be downloaded from one node consecutively. In that, according to the example above, node Y downloads the atonks with the same label from various chunks of node X. This is above all relevant against the backdrop, that the nodes from the PaRL list do not have the entire information contents of the chunk, but only the language and image quality, which they chose for themselves. When node Y thus found the sought-after atonks for chunk 0 with node X, then this will presumably also be the case for chunks 1 to 5. Should this in fact not be the case, or should X have considered a lower quality or another language, respectively, then the missing atonks, in general, must be downloaded from other sources from the respective PaRL list or PeRL list, respectively.

Based on the example explained just now, it now also becomes obvious, why the PaRL lists should always be distributed in their entirety upon using the successor piggyback method. With the successor piggyback method, by passing on from successor to successor, the streaming node learns very fast about the nodes responsible for the replication lists. From these it can immediately download an entire set of PaRL lists for several consecutive identity values. It may then compare these PaRL lists with one another in order to filter out the nodes, from which it can download an entire packet of chunks. Therefore, the PaRL lists must always be present at the comparing node in their entirety. If only a random selection is sent, then this would not provide so many hits in the comparison.

FIG. 5 once again illustrates the use of a buffer with backward buffering in a streaming node. In that, the stored chunks are shown in FIG. 5 by respective bars, which only in part are designated with reference C. In that, the node comprises a temporary buffer B1 with a forward buffer B101 and a backward buffer B102. In that, the forward buffer substantially corresponds to the streaming window according to FIG. 2.

In the backward buffer, the chunks of the stream played already are stored. In that, the playing direction is indicated by arrow P′, and the current playing time is shown by reference Z. As results from FIG. 5, besides streaming, the temporary buffer is also used for providing the chunks for PaRL lists. Beside the temporary buffer B1, a permanent storage B2 is further specified. If this storage has not been filled yet, chunks are downloaded in parallel during streaming of the video, which are permanently made available for other nodes for downloading. These chunks are provided for the respective PeRL lists.

It is explained in the following, according to which criteria a streaming node can select respective download sources from the PeRL or PaRL lists, respectively, it is provided with. In that, any criteria can be used, wherein in the following only examples of possible download sequences are given. First, a streaming node can check, whether it has possibly stored the chunk to be downloaded locally. In that, it in particular checks its buffer (in particular also its backward buffer), the permanent replications deposited therein, whether it has stored a complete copy of the video, or whether the chunk is already being pushed to a sufficient extent based on the above push mechanism.

Should the chunk not be stored locally, first, for example, there may be a search for matching sources in the PaRL lists. In that, the search may take place for the locality considering the IP prefix of the download source, wherein download sources closer to the streaming node are preferred. Furthermore, download sources may be preferred, for which several chunks can be accessed with one connection. This finding can be achieved by comparison of the downloaded PaRL lists of several identity values described above. Further preferred are sources, from which nodes have already been downloaded. There may, however, also be the possibility that download sources are randomly selected from the PaRL lists.

The selection of download sources from PeRL lists may possibly take place down-stream of the selection of download sources from the PaRL lists, i.e. download from the PeRL list is only executed, when no download source in the PaRL list has been found or is not available, respectively. This, however, is not necessarily required, and download sources from PeRL lists may possibly also be used in parallel to the PaRL lists, or first only download sources from the PeRL lists are used.

Upon downloading from the PeRL lists, again, the locality of the download source in respect of the streaming node considering the IP prefix of the download source can be considered, wherein, again, closer download sources are preferred. Likewise, the download source may also be randomly selected from the PeRL list.

For selection of the download sources, above all the atonk map is helpful, which informs the streaming node, which atonks it requires for a certain language or quality. For the still missing atonks, the node checks by means of a request, whether the source provides them. If this is the case, it downloads the atonks. If there is no response to the request, it jumps to another source.

Further criteria for selection of the download sources may, for example, be as follows:
i) for downloading, various download sources are considered for a respective chunk, if possible, in order to keep the impacts of a node failure as low as possible;
ii) download sources with the smallest latency to the streaming node are used for faster data transfer;
iii) for chunks, which are close to the playing time of the video played at the streaming node, download sources from the PeRL list are preferred over the PaRL list, in order to ensure a reliable download.

Once a streaming node has chosen suitable download sources, it initiates the data transfer by sending request messages to each of these sources. In that, the messages are to check, on the one hand, whether the required data are actually located at the respective source. On the other hand, outline conditions for the transfer must be created. In the following, information is listed, which is to be included in this request message:
hash value of the stream;
chunk number(s);
label of the desired atonks;
priority of the request;
data rate reference value;
address of the requesting node;
sending time stamp.

Based on the sending time stamp and the time of receipt, the source can decide, whether the message is still up to date. Old requests are simply discarded. If due to many requests not all can be handled immediately, the queue is processed by times of receipt.

Based on the first three of the points listed above, the download source can be exactly identified, which data are requested, and whether they are available. Via the priority, the download source furthermore detects how important the request is. Depending on that, the download source decides, whether the transfer is performed and how much data rate can be reserved for it.

The data rate reference value transmitted by the requesting node is to inform the download source, which approximate extent the load will have. This value depends on the playing rate or likewise the urgency, with which the atonks are required. For the source, beside the priority, this reference value is a decision criterion, whether it will accept the request. Should the source already be on the verge of utilization, it will reject requests with high reference values.

The various response options of a download source to the request may therefore be:
rejection with reason (for example overloaded);
non-availability of the data;
partial availability of the data and which these are;
acceptance of the entire request.

Beside a suitable selection of download sources, in the embodiment of the method described here, the chunks to be downloaded to the streaming node are provided with various priority numbers and thus divided into various priority classes. With the priority classes, a prioritized download by certain criteria is created, via which it is ensured, that urgently required chunks, for example chunks close to the current playing time of the video, are processed faster and with higher data rates than chunks not so urgently required, for example such chunks, which are downloaded for permanent provision to other nodes. In order to handle requests for higher prioritized chunks, data transfers with a low priority, which are already underway, can be paused or cancelled completely.

In order to keep the playing delay as small as possible, the quality of the chunks to be downloaded may possibly be adapted. In particular, chunks close to the playing time can be downloaded and played with a low quality and thus significantly faster than chunks with a longer distance of time to the playing time. Quality adjustment should in particular be undertaken, when no buffer has been built up by the streaming node yet. With an increasing buffer, the quality of the chunks to be downloaded may then be slowly increased and the playing rate maximized. It is set forth in the following, how in the embodiment of the invention described here, the chunks are divided into priority classes with priorities 1 to 5 and by which characteristics and meanings these priorities are characterized. In that, the priority numbers were selected such that the priority of a chunk is higher, the lower the respective priority number is.

Priority 1:

This priority applies to the entire chunk, which corresponds to the current playing time of the video, however, has not been downloaded yet and is required for immediate playing. I.e., playing has currently been interrupted. The time for downloading this chunk thus corresponds to the playing delay and must be as small as possible. The number of chunks with priority 1 per streaming node is limited to exactly one chunk. The chunk may possibly be distributed to several parallel downloads. In that, the maximum possible data rates of source and sink are exhausted.

Priority 2:

This priority applies to the chunks directly following the playing time, in fact up to that chunk, which marks the end of the download window W illustrated in FIG. 2. In that, the size of the buffer corresponding to this download window is derived from test and empirical values and should fulfill the following criteria: a node with a buffer of the size of the streaming window should stream error-free, if it worked only with priorities 1 and 2. These two priorities, however, must only be used to guarantee a fast start and thereafter stable playing of the stream. Chunks with priorities 1 or 2 particularly occur upon a new start or in case of a jump in the stream, for which a completely new buffer must be built up. These situations are caused by the user of the streaming node and therefore also cannot be predicted. In order not to permanently use these high priorities, whereby they would lose their effectiveness, there must be still further priorities for normal data transfer, which are explained in the following.

Priority 3:

This priority is the standard priority of the nodes, for which the buffer according to the streaming window W of FIG. 2 is completely filled. It is used for the chunks, which are required for filling the buffer from the minimum size, as specified by the streaming window, up to a maximum size. In that, the maximum size is determined in a suitable manner such that chunks with priority 3 are, on average, delivered with just as much data rate as playing consumes. In that, the nodes can let the data rates vary in a very variable manner depending on the load and thus effectively utilize the buffer up to the maximum size. It is desirable, following starting the stream, to get into this class as quickly as possible and to stay there. In that, the download speed is maximized, if possible, however, there should still be space for further data transfers.

Priority 4:

This priority is used for downloading of the chunks permanently available for down-loading by other nodes. The priority is respectively lower, since downloading of the chunks for permanent replication is completely time-uncritical. It is, however, still more important that a normal file transfer, since it should be possible that nodes can access the permanent replication again as quickly as possible. The rates are determined from the capacities currently freely available, and thus fluctuate very much with the utilization and are frequently interrupted.

Priority 5:

This priority corresponds to a normal file transfer. Hereby, it is to be enabled that a video file is not immediately played as a stream, but only accepted. Here, too, the download is completely time-uncritical. The chunks are therefore not selected by order via a streaming window, but randomly selected according to the available capacities. If the user of the streaming node still decides to start the stream early, then he/she is informed, that in this case there is no guarantee for error-free playing. The data rates for priority 5 are solely determined from the still free capacities of the various nodes. Thus, the streaming node sends its requests to the various download sources of all chunks. These may respond, but wait with the data transfer until they have free unused capacities available. In order to prevent the creation of a flood of messages, the permitted number of requests for downloading chunks with priority 5 is limited in time. With this method, free capacities are made usable, since the accepting node itself provides the completely loaded chunks later on. Then they can also be accessed with higher priorities. Following acceptance of the chunk, this node is one of those having the video in its entirety. The download of chunks with priority 5 should thus contribute to stabilizing the network, since nodes, which download a video file with priority 5, normally contribute more to the network than they cause loads. Furthermore, nodes with low resources and data rates are hereby enabled to download a respective video from the network.

Reducing the quality of chunks to be downloaded with high priority, in particular with priorities 1 and 2, the playing delay of a video can be shortened and the buffer built-up accelerated. Hereby, it is achieved that a user, who wants to download a video, does not have to wait very long for the video to be played. For that, he/she may accept a worse quality, but very soon following the start, its optimum is achieved. The quality of the video is preferably influenced by the priority as follows:
All nodes, which download a chunk with priority 1, only select atonks from the chunk, which are required for minimum quality. Thus, the chunk becomes playable faster, the quality, however, is lower than with a download of all atonks from the chunk.
Similar aspects apply to chunks with priority 2. However, here the time, at which the chunk is required, decides which quality is used. The chunk is downloaded until it is either completed or the priority switches to 1. In the second case, the chunk is played immediately, provided that the atonks for the minimum quality are available.
For priority 3, the quality of the chunks depends on the average download rate. This again depends on the possible rates of the sources and the receiver. Since today's Internet connections are very much asynchronous, presumably the upload, i.e. the data rate of the source, will be the criterion determining quality.
For downloads with priorities 4 and 5, the chunks are downloaded in their full size. There's a waiting period until all atonks have been downloaded completely.

Furthermore, the priorities also influence the selection of the sources. Therefore, very time-critical requests are preferably made to those nodes more often, which have the chunks for certain, i.e. which are deposited as entries in the PeRL list of the respective chord node. For that, the following criteria are perceivable, how the download sources are selected depending on the priorities set forth above:
In case of requests for chunks with priority 1, first the nodes from the PeRL list are queried. Should these be overloaded, there may always still be a switch-over to the nodes from the PaRL list. Normally, this enables shorter response times. Since the requested atonks are present for certain, they can also be accepted for certain. Since they furthermore have the highest priority, they are also handled immediately with high probability. Thus, the node must not send the requests to other source nodes again and thus saves time.
Similar aspects apply to the download of chunks with priority 2. Here, however, it is first attempted to get as many atonks as possible from the PaRL list. Only following expiry of a certain period of time, the nodes from the PeRL list are used for the still missing atonks.
For the less important priorities it is attempted to relieve the PeRL nodes as much as possible.

In the embodiment of the method according to the invention described here, a request for a chunk is simultaneously sent redundantly to various download sources. I.e. depending on the priority, several requests for one and the same atonk may also be sent to several different sources. In case of singular downloads, for each chunk only that source is then used, which promises the highest capacity. In case of multiple down-loads, all sources, which accepted the request, are used per chunk and type. For priorities 3, 4 and 5, redundant requests are not necessarily required, since the node has sufficient time to wait.

Once a source for downloading an atonks has been found and the source has accepted a request of the streaming node for a download, the download can be initiated. Depending on the circumstances of the nodes involved in the download, the download takes place in a different manner.

Normally, the data of the video are transferred from the source to the receiver without a “handshake” via UDP. If the receiver acts behind a firewall/NAT, the transfer is handled using TCP. I.e. the streaming node then opens the data connection and thus a port in the firewall. If there is no response to a download request, following expiry of a timer, another source is being sought. The problem of enabling connections in peer-to-peer networks also with nodes, which are located behind barriers, can meanwhile be resolved very well by known mechanisms. These mechanisms may also be used in the embodiment described here for downloading from nodes behind firewalls.

The preferred application of the method described here is streaming of the video, i.e. playing of the video in parallel to its download. For that, for playing, the respective chunk, which is downloaded completely, is decoded, wherein for that a copy of the chunk is generated first, since the original still serves other nodes as a source. With a suitable media player, the decoded file is then played, wherein the locally saved media file is indicated to the media player as the source. In that, the media player does not know how the data get there. To the player it seems as if the media file at this point already contains the entire stream. In this manner, all video-on-demand functions, like fast forwarding or jumping can be realized. If the desired part of the video is not present yet, a respective request of the media player is caught in advance and implemented into the desired chunk number, which is then downloaded from the network as fast as possible, locally decoded and integrated into the media file to be played, so that the media player can play it. Meanwhile, the media player waits. Subsequently, it fills a streaming buffer on its part, which it needs for smooth playing. The mechanism just described allows the use of widely used media players for playing media files streamed with the method according to the invention.

The method described just now has a number of advantages. Using the method, a distribution platform of media contents for most different providers is created, wherein in particular video-on-demand streaming is enabled. In that, the method is based on the implementation of a decentralized structure for each video, wherein individual sections of a video are distributed to various nodes of the structure, so that they can be downloaded by various computers in the network. In that, the system sees to it in the background, that upon streaming, a media file can be played without stopping. The method enables the implementation of video-on-demand as well as of video recorder functions. In that, no central unit is required anymore in order to organize the management or provision of the video exchange. Furthermore, each node, which downloads media contents, is simultaneously also involved in the distribution of the media contents in the network or possibly also in the management of the video in a decentralized structure, respectively.

The method according to the invention can be used in most different areas of application. For example, with the method, free video services or video services against payment can be offered and companies may possibly also provide media material they produced themselves for free for distribution in the market. The method may likewise also be used by private users wishing to provide their own video material in the data network by means of streaming.

1. A method for providing media contents for a plurality of nodes in a data network, wherein said media contents comprise one or several media files and said nodes are addressable in said data network via addresses, wherein:
for each media file to be provided in said data network, a decentralized structure managed via one or several first nodes is formed such that the respective media file is divided into a plurality of sections and an identity value from an identity interval comprising consecutive identity values is allocated to each section, wherein said first node(s) is/are respectively responsible for a sub-interval from said identity interval and hereby for a sub-quantity of sections from the respective media file;
in a respective first node of said decentralized structure, a number of second nodes are deposited with their addresses, wherein said second node(s) is/are specified for providing said sections according to said sub-interval, for which the respective first node is responsible; and
a receiving node specified for downloading at least part of a respective media file retrieves, by of one or several requests to said first nodes in said decentralized structure of said media file, said addresses of second nodes comprising at least part of those second nodes specified for providing said sections of said at least part of the media file, wherein said receiving node downloads sections comprising said sections of said at least part of the media file from at least part of said second nodes, the addresses of which were retrieved.

2. The method according to claim 1, wherein a respective media file contains a playable media stream, and said sections of said media file are consecutive sections of said media stream, wherein said identity values of said identity interval are allocated to said sections in playing sequence of said media stream, so that a higher identity value corresponds to a section in the media stream, which is played later.

3. The method according to claim 2, wherein a receiving node plays said downloaded sections of said media stream in parallel to the download.

4. The method according to claim 1, wherein said decentralized structure is a ring structure and/or is managed via a peer-to-peer protocol, wherein for the respective media file in particular a chord ring is formed.

5. The method according to claim 1, wherein said receiving node provides one or several sections downloaded by said node to other nodes such that said node together with its address is deposited as a second node in said respective first nodes, which are responsible for said sections downloaded by said receiving node.

6. The method according to claim 1, wherein the number of second nodes deposited in a respective first node is replicated in other first nodes, in particular at least in a neighboring node, which is responsible for a sub-interval, which joins said sub-interval, for which the respective first node is responsible.

7. The method according to any of the preceding claims claim 1, wherein the number of second nodes deposited in a respective first node is deposited in the form of one or several lists.

8. The method according to claim 7, wherein said list(s) in a respective first node comprise(s) one or several first and/or second lists, wherein
a first list contains second nodes with sections permanently available for downloading by other nodes, wherein the availability of the respective second node is checked by message exchange of said second node with the respective first node at regular intervals;
a second list comprises those nodes, which retrieved addresses of second nodes from the respective first node within a predetermined past period of time.

9. The method according to claim 8, wherein said receiving node downloads sections from second nodes from said first and/or second list for providing them as permanently available sections, wherein said sections to be downloaded are selected according to one or several predetermined criteria.

10. The method according to claim 8, wherein second nodes from said first list are more preferred for downloading a section to be played by said receiving node, the closer said section to be played lies at the current playing time of said media file.

11. The method according to claim 1, wherein said receiving node, depending on one or several criteria, is accepted as a first node into the decentralized structure of a respective media file by the fact that said receiving node is assigned the responsibility for a sub-interval from said identity interval.

12. The method according to claim 11, wherein the criterion/criteria is/are designed such that for said receiving node, a sub-interval of said identity interval is sought for a maximum number of times, the responsibility of which can be taken over by a new node in said decentralized structure, wherein in case no sub-interval is found after said maximum number of times, said receiving node is not accepted into said decentralized structure as a first node.

13. (canceled)

14. The method according to any of claim 11, wherein said receiving node to be accepted into said decentralized structure is randomly or according to a predetermined pattern assigned a responsibility for a sub-interval, wherein said predetermined pattern is in particular designed such that for sections with low identity values, more first nodes are responsible than for sections with higher identity values.

15. The method according to claim 1, wherein in said decentralized structure a respective first node knows the neighboring node, which is responsible for a sub-interval, which joins the sub-interval, for which said respective first node is responsible, in the direction towards higher identity values, wherein the address of said neighboring node is transmitted to said receiving node by the respective first node upon retrieval of the addresses of said second nodes.

16. (canceled)

17. The method according to claim 1, wherein said sections are downloaded by said receiving node depending on one or several priorities allocated to said sections, wherein sections with higher priorities are preferred for downloading.

18. The method according to claim 17, wherein a respective media file contains a playable media stream, and said sections of said media file are consecutive sections of said media stream, wherein said identity values of said identity interval are allocated to said sections in playing sequence of said media stream, so that a higher identity value corresponds to a section in the media stream, which is played later, wherein a receiving node plays said downloaded sections of said media stream in parallel to the download, wherein a first time interval is specified for a receiving node, wherein said receiving node, starting from its current playing time of said media stream, downloads sections, which in the played media stream lie after the current playing time in said first time interval, with a higher priority than other sections.

19. (canceled)

20. The method according to claim 18, wherein for said receiving node a second time interval is specified, which is larger than said first time interval, wherein said receiving node based on its current playing time of said media stream downloads sections, which in said played media stream lie after said current playing time and outside said first time interval in said second time interval, with a lower priority than said sections within said first time interval.

21. The method according to claim 20, wherein the number of second nodes deposited in a respective first node is deposited in the form of one or several lists, wherein said receiving node downloads sections for providing them as permanently available sections with a lower priority than said sections from said first or second time intervals after said current playing time.

22-27. (canceled)

28. A system for providing media contents for a plurality of nodes in a data network, wherein said media contents comprise one or several media files and said nodes are addressable in said data network via addresses, wherein said system is configured to manage said plurality of nodes such that:
for each media file to be provided in said data network, a decentralized structure managed via one or several first nodes is separately formed such that the respective media file is divided into a plurality of sections and an identity value from an identity interval comprising consecutive identity values is allocated to each section, wherein said first node(s) is/are respectively responsible for a sub-interval from said identity interval and hereby for a sub-quantity of sections from the respective media file;
in a respective first node of said decentralized structure, a number of second nodes are deposited with their addresses, wherein said second node(s) is/are specified for providing said sections according to said sub-interval, for which the respective first node is responsible; and
a receiving node specified for downloading at least part of a respective media file retrieves by means of one or several requests to said first nodes in said decentralized structure of said media file said addresses of second nodes comprising at least part of those second nodes specified for providing said sections of said at least part of the media file, wherein said receiving node downloads sections comprising said sections of said at least part of the media file from at least part of the second nodes, the addresses of which were retrieved.

29. (canceled)

30. A node for use in a method according to claim 1, wherein said node is configured such that upon operation in said method said node acts as a first node or as a second node or as a receiving node.
